(19) United States
(12) Patent Application Publication
(10) Pub. No.: US 2013/0266003 A1
(43) Pub. Date: Oct. 10, 2013

(54) METHOD AND APPARATUS IN GATEWAY FOR TRANSFERRING SWITCHED DIALED DIGITS TO SWITCHED PARTY GATEWAY

(71) Applicants: Yu Xiao, Shanghai (CN); Fangxin Liu, Shanghai (CN); Jianbin Chen, Shanghai (CN)

(72) Inventors: Yu Xiao, Shanghai (CN); Fangxin Liu, Shanghai (CN); Jianbin Chen, Shanghai (CN)

(73) Assignee: ALCATEL-LUCENT, Paris (FR)

(21) Appl. No.: 13/879,900

(22) PCT Filed: Oct. 25, 2011
(86) PCT No.: PCT/IB11/02959

§ 371 Date: Apr. 17, 2013

(30) Foreign Application Priority Data
Nov. 15, 2010 (CN) 201010545359.9

(51) Int. Cl. H04L 29/06

(52) U.S. Cl. CPC H04L 65/1033
USPC 370/352

(57) ABSTRACT

In one embodiment, the method in a gateway for transferring switched dialed digits to a switched party gateway includes A. judging whether switched dialed digits from a user match against a table of overlap dialed numbers; B. if the switched dialed digits match against the table of overlap dialed numbers, then transmitting the switched dialed digits in match to the switched party gateway; and C. if a subsequent switched dialed digit from the user is received, then transmitting the subsequent switched dialed digit to the switched party gateway.

### FIELD OF THE INVENTION

The present invention relates to a switching method in a communication network and in particular to a method and apparatus in a gateway (GW) of a wired communication network for transferring switched dialed digits to a switched party gateway while switching an unattended call.

### BACKGROUND OF THE INVENTION

In a communication network with use of overlap dialing, it is typically difficult to ensure the effect of a switching process in the prior art when a terminal user initiates switching of an unattended call.

En-bloc dialing has been used to collect a directory number of a called party since a PSTN network was replaced with the SIP. An access gateway (AG) is configured with a table of numbers with complete patterns of a directory number and will determine the end of address signaling by acquiring collected dialed digits in match one of the patterns in the table of numbers or upon expiration of a timer between the dialed digits. An initial INVITE message includes a complete directory number to ensure routing of a request to the called party.

Therefore, the unattended call is typically switched in the following two approaches: 1) the end of a called address is determined from the table of numbers with a complete directory number; and 2) the AG typically waits for expiration of the timer between the dialed digits to thereby determine the end of the called address.

In the first approach, the access gateway is typically required to switch to the en-bloc dialing mode to detect a service number for switching the unattended call in the scenario of switching the unattended call in the prior art. In this solution of switching the unattended call, the directory number of the switching destination is based upon en-bloc dialing so that the directory number of the switching destination is transferred in a REFER message.

It is difficult to acquire a table of numbers with a complete directory number, and not all the communication nodes can be configured with a complete table of numbers. Furthermore if a table of numbers with a complete directory number can be acquired, then an operator may not necessarily make use of overlap dialing. Moreover this approach is not practicable in a solution with use of an open dialing policy.

In the second approach, the timer between the dialed digits is typically configured to 10-12 s, and a period of several minutes has to be consumed taking into account as well a period of time for the terminal user to dial all the digits and process the SIP message, which means that the switched party has to wait for a long period of time until the call is switched.

In summary, so far there is still a lack of such a solution enabling an operator to switch an unattended call under the open dialing policy without requiring a terminal user to wait for a long period of time until the call is switched.

### SUMMARY OF THE INVENTION

In view of the drawbacks in the prior art, the invention provides a method and apparatus in a gateway of a wired communication network for transferring switched dialed digits to a switched party gateway while switching an unattended call to thereby address such a technical problem that it is difficult for an operator to switch an unattended call under an open dialing policy and a terminal user has to wait for a long period of time.

In order to address the foregoing technical problem, there is provided according to an embodiment of the invention a method for in a gateway of a communication network for transferring switched dialed digits to a switched party gateway while switching an unattended call, wherein the method includes the steps of: A. judging whether switched dialed digits from a user match against a table of overlap dialed numbers; B. if the switched dialed digits match against the table of overlap dialed numbers, then transmitting the switched dialed digits in match to the switched party gateway; and C. if a subsequent switched dialed digit from the user is received, then transmitting the subsequent switched dialed digit to the switched party gateway.

Optionally the step C further includes: if the subsequent switched dialed digit from the user is received, then transmitting the subsequent switched dialed digit to the switched party gateway in an INFO message in response to a response message from the switched party gateway.

Also there is further provided according to another embodiment of the invention an apparatus in a gateway of a communication network for transferring switched dialed digits to a switched party gateway while switching an unattended call, wherein the apparatus includes: a match judgment module configured to judge whether switched dialed digits from a user match against a table of overlap dialed numbers; a matching switched dialed digit transmitting module configured to, if the switched dialed digits match against the table of overlap dialed numbers, transmit the switched dialed digits in match to the switched party gateway; and a subsequent switched dialed digit transmitting module configured to, if the subsequent switched dialed digit from the user is received, transmit the subsequent switched dialed digit to the switched party gateway.

In the apparatus and method in a gateway of a communication network for transferring switched dialed digits to a switched party gateway while switching an unattended call, if a subsequent switched dialed digit from the user is further received after the switched dialed digits in match are transmitted to the switched party gateway, then the subsequent switched dialed digit from the user is transmitted to the switched party gateway so that the gateway can transmit the subsequent switched dialed digit to the switched party gateway in a timely way while switching the dialed digits so that the gateway can enforce the open dialing policy in the overlapping dialing mode and also can transmit to the switched party gateway a collected number of the switching receiver collected through overlapping dialing.

Furthermore if a subsequent switched dialed digit from the user is received, then the subsequent switched dialed digit is transmitted to the switched party gateway in an INFO message in response to a response message of the switched party gateway to thereby synchronize transmission of the subsequent switched dialed digit with the response message of the switched party gateway and consequentially further secure transmission of the subsequent switched dialed digit. Also in view of that in some communication systems, the switched party gateway generally also transmits the subsequent switched dialed digit to a destination gateway designated by the subsequent switched dialed digit in an INFO message in a dialog while setting up communication with the destination gateway upon reception of the subsequent switched dialed digit to thereby set up the dialog, the subsequent switched dialed digit can be transmitted by being borne in an INFO message in the method or apparatus according to the embodiments of the invention to further enhance compatibility of the embodiments of the invention with the prior art.

### BRIEF DESCRIPTION OF THE DRAWINGS

Other features, objects and advantages of the invention will become more apparent upon reading the following detailed description of non-limiting embodiments with reference to the drawings in which:

FIG. 1 is a topology structural diagram of a communication network system according to an embodiment of the invention;

FIG. 2 is a flow chart of a method for transmitting switched dialed digits to a switched party gateway according to an embodiment of the invention;

FIG. 3 is a flow chart of an application scenario of a method for transmitting switched dialed digits to a switched party gateway according to another embodiment of the invention: and

FIG. 4 is a structural schematic diagram of an apparatus for transmitting switched dialed digits to a switched party gateway according to another embodiment of the invention.

Identical or like reference numerals denote identical or like step features or means (modules).

### DETAILED DESCRIPTION OF THE INVENTION

Overlap dialing based upon an SIP application scenario is defined during evolvement of the PSTN to the IMS architecture to support a network under an open dialing policy. In the case of the open dialing policy, dialed digits to be received are unknown to an access gateway. Only a smallest number of dialed digits sufficient for routing of an initial INVITE message to the next communication entity will be received prior to transmission of the INVITE message. Subsequent dialed digits will be transferred somehow over a route. Two methods are defined in the document of TISPAN TS 183043 for this purpose: the multi-INVITE method and the in-dialog method.

In either of the foregoing methods, a switched party gateway shall know subsequent switched dialed digits of a terminal user accessing a switching party gateway.

A detailed illustrative description will be presented below of how to transmit in a switching party gateway the subsequent switched dialed digits to a switched party gateway in embodiments of the invention with reference to the drawings.

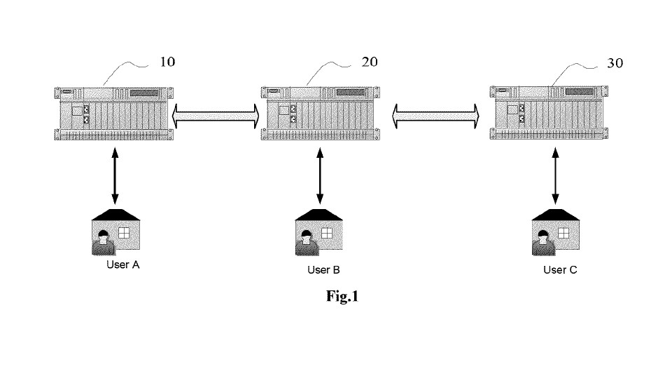

FIG. 1 is a topology structural diagram of a communication network system according to an embodiment of the invention. In this embodiment and as illustrated, a user A accesses a switching party gateway 10, a user B accesses a switched party gateway 20, and a user C acts as a switching destination and accesses a switching destination gateway 30. Assumed the user A in communication with the user B through the switching party gateway 10 and the switched party gateway 20 shall switch the dialog to the user C to thereby finally set up a dialog between the user B and the user C. Particularly the switching party gateway 10 operates in the overlap dialing mode and supports the open dialing policy so that a table of numbers stored in the switching party gateway 10 can include only a part of a complete number of the switching destination.

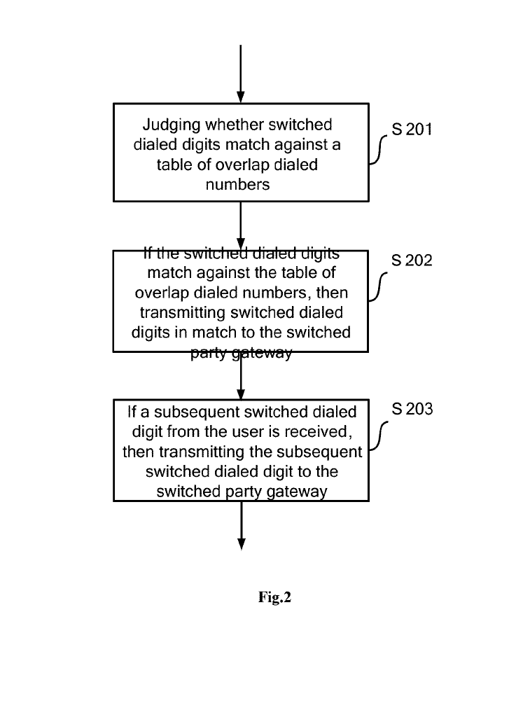

FIG. 2 is a flow chart of a method for transmitting switched dialed digits to a switched party gateway according to an embodiment of the invention, where the switched dialed digits refer to a number of a switching receiver collected by the gateway through overlap dialing. The method according to the embodiment includes a match judgment step S201, a matching switched dialed digit transmitting step S202 and a subsequent switched dialed digit transmitting step S203.

The user A shall firstly perform a flash-hook operation before switching the dialog thereof with the user B to the user C, and the switching party gateway 10 will also enter the status of collecting switched dialed digits from the user A through overlap dialing in response to the flash-hook operation.

In the foregoing status, it is firstly judged in the step S201 whether switched dialed digits from the user A match against a table of overlap dialed numbers.

Next in the step S202, if the switched dialed digits match against the table of overlap dialed numbers, then switched dialed digits in match are transmitted to the switched party gateway 20.

Next in the step S203, if a subsequent switched dialed digit from the user A is received, then the subsequent switched dialed digit is transmitted to the switched party gateway 20.

Taking into account the open dialing policy supportable by the switching party gateway 10, the table of overlap dialed numbers can optionally include a part of a called number of the terminal accessing the destination gateway. For example, if a complete number is “345678”, then a table entry “3456” corresponding to the complete number may be present in the table of overlap dialed numbers in the switching party gateway 10.

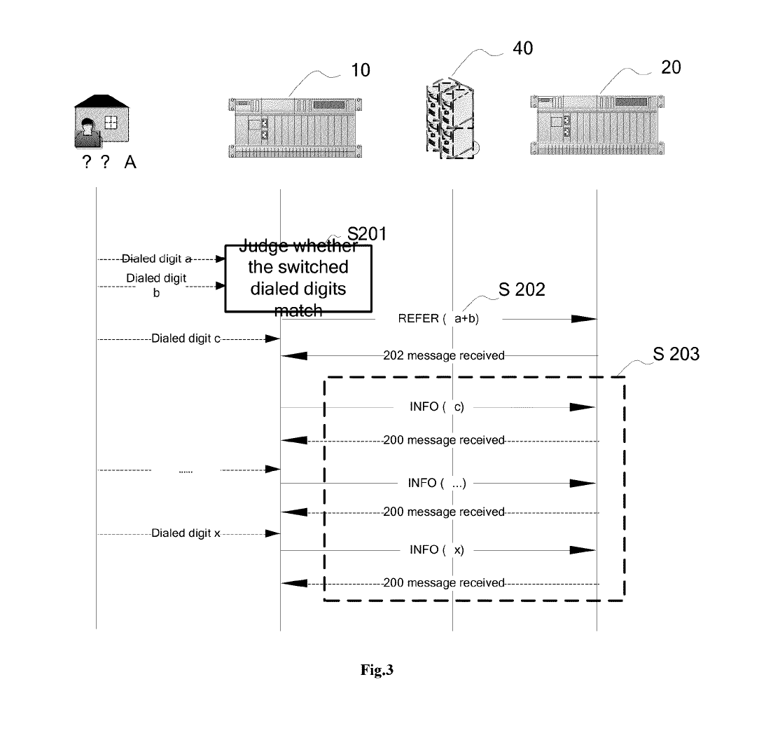

FIG. 3 is a flow chart of a method for transmitting switched dialed digits to a switched party gateway according to another embodiment of the invention in an application scenario of switching an unattended call. This Figure shows that the switching party gateway 10 transmits, to the switched party gateway 20, switched dialed digits from the user A collected through overlapping dialing in the steps 5201, S202 and S203 in response to an operation of the user A.

Assumed there is an entry of “ab” in the table of overlap dialed numbers stored in the switching party gateway 10. Firstly the code of an unattended call switching service and thereafter switching digits “a” and “b” are dialed at the side of the user A, and also during this process, at the side of the switching party gateway 10, the switching party gateway 10 receives the code of the switching service and judges whether what dialed by the user A is the code of the unattended call switching service and thereafter enters the scenario of an unattended call switching application and receives the switching digits “a” and “b” dialed by the user. At this time in the step S201, the switching party gateway 10 judges from the switched dialed digits “a” and “b” from the user A whether the switched dialed digits match against the table of overlap dialed numbers. Next in the step S202, the switching party gateway 10 detects matching of the switched dialed digits “a” and “b” with the entry of “ab” in the table of overlap dialed numbers and then transmits the switched dialed digits “a” and “b” in match to the switched party gateway 20 in a REFER message. Then in the step S203, if the switching party gateway 10 receives a subsequent switched dialed digit from the user A, e.g., “c”, then optionally the subsequent switched dialed digit “c” is transmitted to the switched party gateway 20 in an INFO message.

Optionally in the step S203, if the switching party gateway 10 receives a subsequent switched dialed digit from the user A, then the subsequent switched dialed digit is transmitted to the switched party gateway in an INFO message in response to a replay message of the switched party gateway. For example, after 1 ms elapses since the switching party gateway 10 transmits the switched dialed digits “ab” in match to the switched party gateway 20 in a REFER message in the step S202, the switching party gateway 10 further receives the subsequent switched dialed digit “c” from the user A and thereafter further receives from the switched party gateway 20 a 202 response message regarding successful reception of the REFER message, and then as illustrated, the switching party gateway 10 transmits the subsequent switched dialed digit “c” to the switched party gateway 20 in an INFO message in response to the 202 message, in the step S203.

Furthermore the switched party gateway 20 can transmit information on the switched dialed digits “ab” in match to the switching destination gateway 30 in an INVITE message according to a corresponding communication protocol upon reception of the REFER message including the switched dialed digits “ab” in match so that the switching destination gateway 30 uses the information on the switched dialed digits “ab” for communication thereof with the switching destination, i.e., the user C.

Optionally a response step in the step S203 further includes transmitting to the switched party gateway 20 a second set of consecutive dialed digits among the subsequent switched dialed digits in an INFO message in response to the response message of the switched party gateway 20 to an INFO message including a first set of consecutive dialed digits among the subsequent switched dialed digits, where the first set of consecutive dialed digits or the second set of consecutive dialed digits includes one dialed digit or more than one consecutive dialed digit.

As illustrated in FIG. 3, the switching party gateway 10 receives a 200 message feedback from the switched party gateway 20 regarding successful reception of the INFO message including the switched dialed digit “c” and transmits the subsequent switched dialed digits represented with “. . . ” in FIG. 3 to the switched party gateway 20 respectively in an INFO message in response to the 200 message corresponding to the switched dialed digit “c”. As illustrated, a further subsequent switched dialed digit “x” from the user A is further received upon reception of a 200 response message corresponding to the last dialed digit among the subsequent switched dialed digits represented with “. . . ”, and then the subsequent switched dialed digit “x” is further transmitted to the switched party gateway 20 in an INFO message. This procedure is repeated until no subsequent switched dialed digit from the user A is further received or the reception timer expires.

Of course, optionally the switching party gateway 10 continuously receives several consecutive switched dialed digits “d”, “e” and “f” from the user A after transmitting the switched dialed digit “c” to the switched party gateway 20 in the INFO message. Then the switching party gateway 10 further receives a 200 message feedback from the switched party gateway 20 regarding successful reception of the INFO message corresponding to the switched dialed digit “c” and then can also transmit the three switched dialed digits “d”, “e” and “f” once to the switched party gateway 20 in an INFO message in response to the 200 message corresponding to the switched dialed digit “c”.

Furthermore the switched party gateway 20 can transmit information on the subsequent switched dialed digits “c, x” sequentially to the switching destination gateway 30 sequentially in a plurality of INVITE messages (e.g., INVITE (a+b+c), INVITE (a+b+c+d) INVITE (a+b+c+d+. . . x)) in a multi-INVITE mode or sequentially in a plurality of INFO messages (e.g., INFO (c), INFO (d), . . . , INFO (x)) in the hi-dialog mode according to a corresponding communication protocol upon reception of the subsequent switched dialed digits “c, x” so that the switching destination gateway 30 uses the information on the subsequent switched dialed digits “c, x” for subsequent communication thereof with the switching destination, i.e., the user C.

In another embodiment of the invention, the communication network further includes an application server 40, and correspondingly in the step S202, if the switched dialed digits match against the table of overlap dialed numbers, then the switching party gateway 10 transmits the switched dialed digits in match to the switched party gateway 20 via the application server 40, and in the step S203, if the subsequent switched dialed digit from the user A is received, then the subsequent switched dialed digit is transmitted to the switched party gateway via the application server 40. Of course, the application server 40 can also perform some further processes while forwarding a corresponding INFO message including the subsequent switched dialed digit.

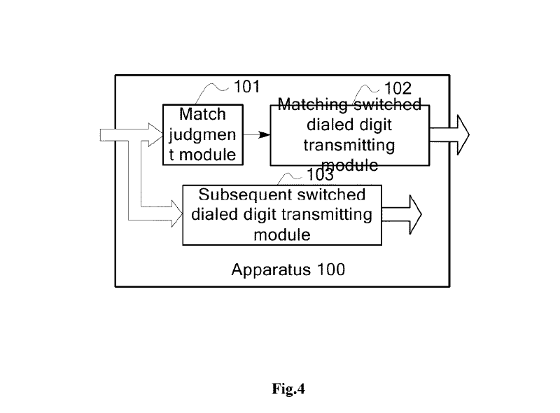

FIG. 4 shows a structural schematic diagram of an apparatus for transmitting switched dialed digits to a switched party gateway according to another embodiment of the invention. As illustrated, the apparatus is typically arranged in the switching party gateway 10 and includes a match judgment module 101, a matching switched dialed digit transmitting module 102 and a subsequent switched dialed digit transmitting module 103.

The match judgment module 101 is configured to judge whether switched dialed digits from a user match against a table of overlap dialed numbers.

The matching switched dialed digit transmitting module 102 is configured to, if the switched dialed digits match against the table of overlap dialed numbers, transmit the switched dialed digits in match to the switched party gateway 20.

The subsequent switched dialed digit transmitting module 103 is configured to, if a subsequent switched dialed digit from the user is received, transmit the subsequent switched dialed digit to the switched party gateway 20.

Assumed there is an entry of “ab” in the table of overlap dialed numbers stored in the match judgment module 101. Firstly the code of an unattended call switching service and thereafter switching digits “a” and “b” are dialed at the side of the user A, and also at the side of the switching party gateway 10, the match judgment module 101 judges whether the switching digits “a” and “b” from the user A match against the table of overlap dialed numbers. Next the matching switched dialed digit transmitting module 102 detects matching of the switched dialed digits “a” and “b” with the entry of “ab” in the table of overlap dialed numbers and then transmits the switched dialed digits “a” and “b” in match to the switched party gateway 20 in a REFER message. Then if the subsequent switched dialed digit transmitting module 103 receives a subsequent switched dialed digit from the user A, e.g., “c”, then optionally the subsequent switched dialed digit “c” is transmitted to the switched party gateway 20 in an INFO message.

Optionally if the subsequent switched dialed digit transmitting module 103 receives a subsequent switched dialed digit from the user A, then the subsequent switched dialed digit is transmitted to the switched party gateway 20 in an INFO message in response to a replay message of the switched party gateway 20. For example, after 1 ms elapses since the matching switched dialed digit transmitting module 102 transmits the switched dialed digits “a” and “b” in match to the switched party gateway 20 in a REFER message in the step S202, the subsequent switched dialed digit transmitting module 103 further receives the subsequent switched dialed digit “c” from the user A and thereafter further receives from the switched party gateway 20 a 202 response message regarding successful reception of the REFER message, and then as illustrated, the subsequent switched dialed digit transmitting module 103 transmits the subsequent switched dialed digit “c” to the switched party gateway 20 in an INFO message in response to the 202 message.

Optionally a response sub-module in the subsequent switched dialed digit transmitting module 103 is further configured to transmit to the switched party gateway 20 a second set of consecutive dialed digits among the subsequent switched dialed digits in an INFO message in response to the response message of the switched party gateway 20 to an INFO message including a first set of consecutive dialed digits among the subsequent switched dialed digits, where the first set of consecutive dialed digits or the second set of consecutive dialed digits includes one dialed digit or more than one consecutive dialed digit.

As illustrated in FIG. 3, the subsequent switched dialed digit transmitting module 103 receives a 200 message feedback from the switched party gateway 20 regarding successful reception of the INFO message including the switched dialed digit “c” and then transmits the subsequent switched dialed digits represented with “. . . ” in FIG. 3 to the switched party gateway 20 respectively in an INFO message in response to the 200 message corresponding to the switched dialed digit “c”. As illustrated, a further subsequent switched dialed digit “x” from the user A is further received upon reception of a 200 response message corresponding to the last dialed digit among the subsequent switched dialed digits represented with “. . . ”, and then the subsequent switched dialed digit “x” is further transmitted to the switched party gateway 20 in an INFO message. This procedure is repeated until no subsequent switched dialed digit from the user A is further received or the reception timer expires or a notice message NOTIFY transmitted from the switched party gateway has been received notifying the switched party about ringing, answering or rejection of the dialog of the switching destination party.

Of course, optionally the subsequent switched dialed digit transmitting module 103 continuously receives several consecutive switched dialed digits “d”, “e” and “f” from the user A after transmitting the switched dialed digit “c” to the switched party gateway 20 in the INFO message. Then the subsequent switched dialed digit transmitting module 103 further receives a 200 message feedback from the switched party gateway 20 regarding successful reception of the INFO message corresponding to the switched dialed digit “c” and then the switching party gateway 10 can also transmit the three switched dialed digits “d”, “e” and “f” once to the switched party gateway 20 in an INFO message in response to the 200 message corresponding to the switched dialed digit “c”.

In another embodiment of the invention, the communication network further includes an application server 40, and correspondingly the matching switched dialed digit transmitting module 102 is further configured to, if the switched dialed digits match against the table of overlap dialed numbers, then transmit the switched dialed digits in match to the switched party gateway 20 via the application server 40, and the subsequent switched dialed digit transmitting module 103 is further configured to, if the subsequent switched dialed digit from the user A is received, then transmit the subsequent switched dialed digit to the switched party gateway via the application server 40. Of course, the application server 40 can also perform some further processes while forwarding a corresponding INFO message including the subsequent switched dialed digit.

Those skilled in the art can appreciate the respective means as referred to in the invention can be implemented with a hardware module or with a functional module in software or with a hardware module integrated with a software functional module.

Those skilled in the art can appreciate that the foregoing embodiments are illustrative but not limiting. Different technical features present in the different embodiments can be combined to advantage. Those skilled in the art can appreciate alternative embodiments to the disclosed embodiments upon studying the drawings, the description and the claims. In the claims, the term “comprise” will not preclude another element or step, the infinite article “a(n)” will not preclude more than one, and the term “a(the) first”, “a(the) second”, etc., are used to designate names but not represent any specific sequence. Any reference numerals in the claims shall not be constructed as limiting the scope of the invention. Functions of more than one element present in the claims can be performed with a separate hardware or software module. Presence of some technical features in different appended claims will not mean that these technical features can not be combined to advantage.

1. A method in a gateway of a communication network for transferring switched dialed digits to a switched party gateway while switching an unattended call, wherein the method comprises:
A. judging whether switched dialed digits from a user match against a table of overlap dialed numbers;
B. if the switched dialed digits match against the table of overlap dialed numbers, then transmitting the switched dialed digits in match to the switched party gateway; and
C. if a subsequent switched dialed digit from the user is received, then transmitting the subsequent switched dialed digit to the switched party gateway.

2. The method according to claim 1, wherein the step B further comprises: if the switched dialed digits match against the table of overlap dialed numbers, then transmitting the switched dialed digits in match to the switched party gateway in a REFER message.

3. The method according to claim 1, wherein the step C further comprises:
if the subsequent switched dialed digit from the user is received, then transmitting the subsequent switched dialed digit to the switched party gateway in an INFO message in response to a response message from the switched party gateway.

4. The method according to claim 3, wherein a response step in the step C further
transmitting to the switched party gateway a second set of consecutive dialed digits among the subsequent switched dialed digits in an INFO message in response to the response message of the switched party gateway to a first set of consecutive dialed digits among the subsequent switched dialed digits, wherein the first set of consecutive dialed digits or the second set of consecutive dialed digits includes one dialed digit or more than one consecutive dialed digit respectively.

5. The method according to claim 1, wherein the communication network further comprises an application server, and the step B further comprises:
if the switched dialed digits match against the table of overlap dialed numbers, then transmitting the switched dialed digits in match to the switched party gateway via the application server; and the step C further comprises:
if the subsequent switched dialed digit from the user is received, then transmitting the subsequent switched dialed digit to the switched party gateway via the application server.

6. An apparatus in a gateway of a communication network for transferring switched dialed digits to a switched party gateway while switching an unattended call, wherein the apparatus comprises:
a match judgment module configured to judge whether switched dialed digits from a user match against a table of overlap dialed numbers;
a matching switched dialed digit transmitting module configured to, if the switched dialed digits match against the table of overlap dialed numbers, transmit the switched dialed digits in match to the switched party gateway; and
a subsequent switched dialed digit transmitting module configured to, if the subsequent switched dialed digit from the user is received, transmit the subsequent switched dialed digit to the switched party gateway.

7. The apparatus according to claim 6, wherein the matching switched dialed digit transmitting module is further configured to, if the switched dialed digits match against the table of overlap dialed numbers, transmit the switched dialed digits in match to the switched party gateway in a REFER message.

8. The apparatus according to claim 6, wherein the subsequent switched dialed digit transmitting module is further configured to, if the subsequent switched dialed digit from the user is received, transmit the subsequent switched dialed digit to the switched party gateway in an INFO message in response to a response message from the switched party gateway.

9. The apparatus according to claim 8, wherein a response sub-module in the subsequent switched dialed digit transmitting module is further configured to transmit to the switched party gateway a second set of consecutive dialed digits among the subsequent switched dialed digits in an INFO message in response to the response message of the switched party gateway to a first set of consecutive dialed digits among the subsequent switched dialed digits, wherein the first set of consecutive dialed digits or the second set of consecutive dialed digits includes one dialed digit or more than one consecutive dialed digit respectively.

10. The apparatus according to claim 6, wherein the communication network further comprises an application server, and the matching switched dialed digit transmitting module is further configured to, if the switched dialed digits match against the table of overlap dialed numbers, then transmit the switched dialed digits in match to the switched party gateway via the application server; and the subsequent switched dialed digit transmitting module is further configured to, if the subsequent switched dialed digit from the user is received, then transmit the subsequent switched dialed digit to the switched party gateway via the application server.
